(19) United States
(12) Patent Application Publication
(10) Pub. No.: US 2013/0158865 A1
(43) Pub. Date: Jun. 20, 2013

(54) METHOD AND APPARATUS FOR ESTIMATING POSITION OF MOVING OBJECT

(71) Applicant: ELECTRONICS AND TELECOMMUNICATIONS R, Daejeon (KR)

(72) Inventors: Ki In NA, Daejeon (KR); Yu-Cheol LEE, Daejeon (KR); Jaemin BYUN, Daejeon (KR); Myung Chan ROH, Daejeon (KR); Sung Hoon KIM, Daejeon (KR)

(73) Assignee: ELECTRONICS AND TELECOMMUNICATIONS RESEARCH INSTITUTE, Daejeon (KR)

(21) Appl. No.: 13/705,267

(22) Filed: Dec. 5, 2012

(30) Foreign Application Priority Data
Dec. 15, 2011 (KR) 10-2011-0135225

(51) Int. Cl. G01C 21/00

(52) U.S. Cl. CPC G01C 21/005
USPC 701/448; 701/446

(57) ABSTRACT

An apparatus of estimating a position of a moving object creates a global map for a space over which the moving object is moving, on the basis of environment information on moving distance, measured distance, captured image and GIS data, and attribute and position of obstacles within the space. The method also creates a local map on the basis of the environment information obtained from around the moving object, and estimates a position of the moving object on the global map through matching of the local map and the global map.

### RELATED APPLICATION(S)

This application claims the benefit of Korean Patent Application No. 10-2011-0135225, filed on Dec. 15, 2011, which is hereby incorporated by reference as if fully set forth herein.

### FIELD OF THE INVENTION

The present invention relates to technology of estimating a position of a moving object, and more particularly, to an apparatus and method for estimating a position of a moving object on a global map through matching of the global map and a local map.

### BACKGROUND OF THE INVENTION

Recently, due to graying and the advancement of robot technologies, consumers' demand for a self-driving vehicle increases. In order for robots or self-driving vehicles to safely and autonomously run outdoors, it is required to accurately detect the positions of the robots or the self-driving vehicles. To this end, relatively expensive sensors such as RTK-DGPS (Real Time Kinematic-Differential Global Positioning System), LIDAR (LIght Detection And Ranging), and INS (Inertial Navigation System) have been used. However, these sensors are very expensive and therefore, it is not suitable to apply the sensors to robots or self-driving vehicles that the public uses. Even though using an expensive sensor, the stability of the performance of the sensors may be reduced depending on an environment in which a robot or a self-driving vehicle drive, and thus, it is required to develop position recognition technology without using the expensive sensors and is less affected by an environment.

### SUMMARY OF THE INVENTION

In view of the above, the present invention provides an apparatus and method that accurately create a global map with a low-cost sensor such as a laser scanner and compare the global map and a local map, generated on the basis of environment information which is obtained when a moving object moves, to accurately estimate a position of the moving object.

The object of the present invention is not limited to the aforesaid, but other objects not described herein will be clearly understood by those skilled in the art from descriptions below.

In accordance with a first aspect of the present invention, there is provided an apparatus for estimating a position of a moving object, the apparatus including: a sensor module configured to obtain environment information on moving distance and measured distance of the moving object, captured image around the moving object, and GIS data of the moving object; a map standard storage unit for storing information on attribute and position of obstacles in a space over which the moving object is moving; a global map creating unit configured to create a global map for the space on the basis of the environment information obtained by the sensor module and the information on the attribute and position of the obstacles stored in the map standard storage unit; a local map creating unit configured to receive the environment information to create a local map; and a matching unit configured to estimate a position of the moving object on the global map through matching of the local map and the global map.

Preferably, the global map creating unit is further configured to apply the moving distance, measured distance, captured image, and GIS data to an extended Kalman filter or a particle filter to calculate a global position of the moving object and create the global map for the space using the global position and the attribute and position information of the obstacles.

Preferably, the global map creating unit provides an interface for comparing the GIS data and a position of the moving object, and the global map creating unit is configured to calculate a global position of the moving object on the basis of the compared result and create the global map using the global position of the moving object and the attribute and position information of the obstacles.

Preferably, the local map creating unit is configured to receive the environment information around the moving object at predetermined intervals to create the local map.

Preferably, the local map creating unit is configured to receive the environment information around the moving object from the sensor module, and create the local map within a predetermined range with respect to the position of the moving object on the basis of the environment information.

Preferably, the matching unit is configured to extract the attribute information including lanes, height of obstacles, and road marks from the local map and estimate a position of the moving object on the global map through matching between information of the global map and the extracted information.

In accordance with a second aspect of the present invention, there is provided a method of estimating a position of a moving object, the method including: creating a global map for the space over which the moving object is moving, on the basis of environment information on moving distance, measured distance, captured image and GIS data and information on attribute and position of obstacles within the space; creating a local map on the basis of environment information obtained from around the moving object moving over the space; and estimating a position of the moving object on the global map through matching of the local map and the global map.

Preferably, the creating the global map includes:

calculating a global position of the moving object by applying the information on moving distance, measured distance, captured image, and GIS data to an extended Kalman filter or a particle filter; and creating the global map using the global position and the attribute and position information of the obstacles.

Preferably, the creating the global map includes: providing an interface for comparing the GIS data and the position of the moving object; calculating the global position of the moving object on the basis of the compared result; and creating the global map using the global position of the moving object and the attribute and position information of the obstacles.

Preferably, the creating the local map includes generating the local map on the basis of the environment information, obtained at predetermined intervals, around the moving object when the moving object is moving.

Preferably, the creating the local map includes generating the local map within a predetermined range with respect to the position of the moving object on the basis of the environment information during the moving object is moving.

Preferably, the estimating the position of the moving object includes: extracting the attribute information including lanes, height of obstacles, and road marks from the local map; and estimating the position of the moving object on the global map through matching between information of the global map and the extracted information.

### BRIEF DESCRIPTION OF THE DRAWINGS

The above and other objects and features of the present invention will become apparent from the following description of embodiments given in conjunction with the accompanying drawings, in which:

FIG. 1 is a block diagram of an apparatus for estimating a position of a moving object, in accordance with an embodiment of the present invention; and

FIG. 2 is a flowchart illustrating a method of estimating a position of a moving object, in accordance with an embodiment of the present invention.

### DETAILED DESCRIPTION OF THE EMBODIMENTS

Hereinafter, an apparatus and a method that estimate a position of a moving object by using a global map and a local map, which is generated on the basis of environment information that is obtained when the moving object is running, will be described with reference to the accompanying drawings.

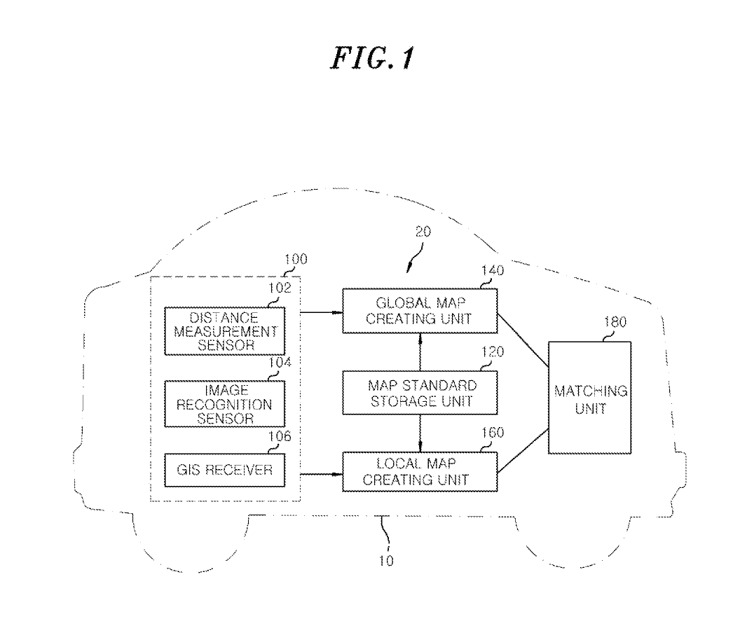

FIG. 1 is a block diagram of an apparatus for estimating a position of a moving object, in accordance with an embodiment of the present invention.

Referring to FIG. 1, an apparatus 20 for estimating a position of a moving object 10 includes a sensor module 100, a map standard storage unit 120, a global map creating unit 140, a local map creating unit 160, and a matching unit 180.

In an embodiment of the present invention, the moving object 10 may be a robot or a self-driving vehicle, and the apparatus 20 may be mounted on the moving object 10.

The sensor module 100 obtains environment information necessary for creating a global map and a local map. To this end, the sensor nodule 100 includes a distance measurement sensor 102, an image recognition sensor 104, and a GIS (Geographic Information System) receiver 106.

The distance measurement sensor 102, which may be a laser sensor, obtains a moving distance of the moving object 10 moving over a space, and a measured distance between the moving object 10 and adjacent objects in the space. The image recognition sensor 104 captures an image around the moving object moving over the space. The GIS receiver 106 receives GIS data from a GIS, such as a Google map, in communication with a map server (not shown). The moving distance and measured distance, the captured images, and the GIS data are supplied to the global map creating unit 140 and the local map creating unit 160.

The map standard storage unit 120 stores map standard data therein. The map standard data may take a multi-layer format, and includes information on the position and attribute of obstacles in the space. Herein, the position information of the obstacles indicates whether there are obstacles at arbitrary positions in the space over which the moving object is moving using the distance measurement sensor 102 and the moving distance of the moving object 10, and the attribute information of the obstacles indicates the basic characteristic of the obstacles. As an example, the basic attribute information may include attribute information such as a height of an obstacle, a lane and a road mark.

The global map creating unit 140 creates a whole map, i.e., a global map, for the space over which the moving object 10 is moving. More specifically, the global map creating unit 140 calculates a global position of the moving object 10 on the basis of the moving distance, measured distance and GIS data of the moving object 10, and captured image around the moving object 10 which are obtained by the sensor module 100. Also, the global map creating unit 140 extracts the position and attribute of the obstacles in the space from the map standard data stored in the map standard storage unit 120, and creates the global map in which the global position of the moving object 10 is indicated along with the position and attribute of the obstacles.

During the calculation the position of the moving object, a slip of a floor surface in the space may cause to lead an incorrectness of the position of the moving object 10. According to the embodiment, in order to compensate the incorrectness due to the slip and correctly obtain the position of the moving object 10, various filters such as an extended Kalman filter and a particle filter may be applied to the moving distance and measured distance of the moving object 10, captured image around the moving object 10, and GIS data of the moving object 10.

Alternatively, the global map creating unit 140 may provide an interface for comparing a current position of the moving object 10 and the GIS data obtained from the sensor module 100 by a user his/her self to correctly calculate the global position of the moving object.

The local map creating unit 160 creates a local map at a predetermined interval or within a predetermined range with respect to the position of the moving object 10, on the basis of information including the measured distance, the moving distance, the captured image, and the GIS data which are in real time obtained from the sensor module 100 while the moving object is moving. Further, the local map creating unit 160 extracts attribute information such as lanes, height of obstacles, and road marks from the local map. The extracted information is then supplied to the matching unit 180.

The matching unit 180 estimates a position of the moving object 10 on the global map through matching of information included in the local map and information included in the global map. In detail, the matching unit 180 matches the attribute information including the lanes, the height of obstacles, and the road marks with their respective corresponding information in the global map to thereby estimates the position of the moving object on the global map.

Therefore, according to an embodiment of the present invention, the apparatus for estimating the position of the moving object generates a global map for a space over which the moving object is moving, generates a local map on the basis of environment information which is obtained during the moving object is moving, and displays the position of the moving object on the global map through matching of the global map and the local map, thereby accurately estimating the position of the moving object.

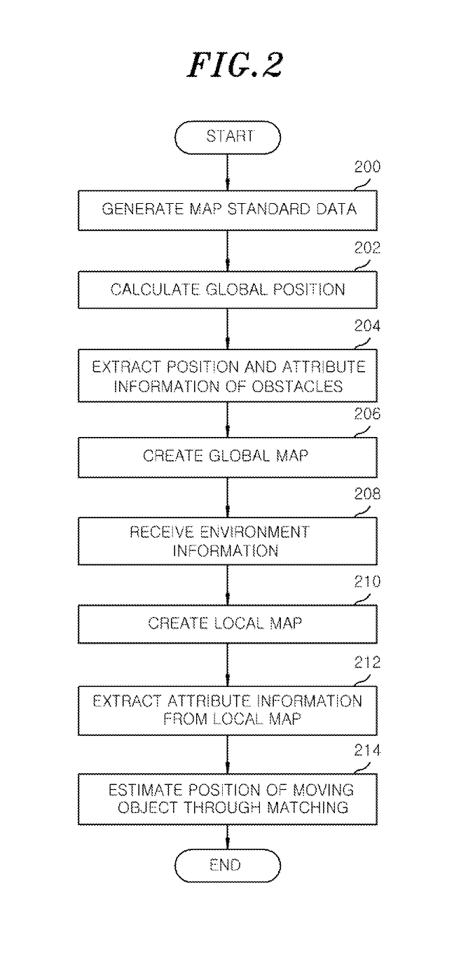

An operation of the moving-object position estimation apparatus having the above-described configuration will now be described with reference to FIG. 2.

FIG. 2 is a flowchart illustrating a method of estimating a position of a moving object in accordance with an embodiment of the present invention.

Referring to FIG. 2, in operation 200, the apparatus 20 for estimating a position of the moving object generates map standard data including information on the position and attribute of obstacles in a space over which the moving object is moving, and stores the generated map standard data in the map standard storage unit 120.

Subsequently, in operation 202, the global map creating unit 140 calculates a global position of the moving object 10 on the basis of the moving distance, measured distance, captured images, and GIS data of the moving object 10. Thereafter, in operation 204, the global map creating unit 140 extracts the position and attribute information of the obstacles from the map standard data stored in the map standard storage unit 120.

In subsequence, in operation 206, the global map creating unit 140 creates a global map including the global position of the moving object 10 and the position and attribute of the obstacles. The created global map is then supplied to the matching unit 180.

After that, the local map creating unit 160 receives environment information around the moving object 10 from the sensor module 100 during the moving object is moving in operation 208, and creates a local map at a predetermined interval or within a predetermined range with respect to the moving object 10 based on the environment information in operation 210, wherein the environment information may include measured distance, moving distance, captured image, and GIS data. The created local map is then supplied to the matching unit 180.

The matching unit 180 extracts the attribute information on the lanes, the height of obstacles, and the road marks from the global map in operation 212, and estimates the position of the moving object 10 on the global map through matching of the extracted information and its corresponding information in the global map in operation 214.

As described above, the present invention generates a global map for a space over which the moving object is moving, generates a local map on the basis of environment information obtained during the moving object is moving, and estimates a position of the moving object on the global map through matching of the global map and the local map, thus accurately estimating the position of the moving object.

Accordingly, even without using an expensive sensor, the embodiment may accurately estimate a position of a moving object such as a robot or a self-driving vehicle, thereby facilitating the popularization and industrialization of robots and self-driving vehicles.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for estimating a position of a moving object, the apparatus comprising:
a sensor module configured to obtain environment information on moving distance and measured distance of the moving object, captured image around the moving object, and GIS data of the moving object;
a map standard storage unit for storing information on attribute and position of obstacles in a space over which the moving object is moving;
a global map creating unit configured to create a global map for the space on the basis of the environment information obtained by the sensor module and the information on the attribute and position of the obstacles stored in the map standard storage unit;
a local map creating unit configured to receive the environment information to create a local map; and
a matching unit configured to estimate a position of the moving object on the global map through matching of the local map and the global map.

2. The apparatus of claim 1, wherein the global map creating unit is further configured to apply the moving distance, measured distance, captured image, and GIS data to an extended Kalman filter or a particle filter to calculate a global position of the moving object and create the global map for the space using the global position and the attribute and position information of the obstacles.

3. The apparatus of claim 1, wherein the global map creating unit provides an interface for comparing the GIS data and a position of the moving object, and
wherein the global map creating unit is configured to calculate a global position of the moving object on the basis of the compared result and create the global map using the global position of the moving object and the attribute and position information of the obstacles.

4. The apparatus of claim 1, wherein the local map creating unit is configured to receive the environment information around the moving object at predetermined intervals to create the local map.

5. The apparatus of claim 1, wherein the local map creating unit is configured to receive the environment information around the moving object from the sensor module, and create the local map within a predetermined range with respect to the position of the moving object on the basis of the environment information.

6. The apparatus of claim 1, wherein the matching unit is configured to extract the attribute information including lanes, height of obstacles, and road marks from the local map and estimate a position of the moving object on the global map through matching between information of the global map and the extracted information.

7. A method of estimating a position of a moving object, the method comprising:
creating a global map for the space over which the moving object is moving, on the basis of environment information on moving distance, measured distance, captured image and GIS data and information on attribute and position of obstacles within the space;
creating a local map on the basis of environment information obtained from around the moving object moving over the space; and
estimating a position of the moving object on the global map through matching of the local map and the global map.

8. The method of claim 7, wherein said creating the global map comprises:
calculating a global position of the moving object by applying the information on moving distance, measured distance, captured image, and GIS data to an extended Kalman filter or a particle filter; and
creating the global map using the global position and the attribute and position information of the obstacles.

9. The method of claim 7, wherein said creating the global map comprises:
providing an interface for comparing the GIS data and the position of the moving object;
calculating the global position of the moving object on the basis of the compared result; and
creating the global map using the global position of the moving object and the attribute and position information of the obstacles.

10. The method of claim 7, wherein said creating the local map comprises generating the local map on the basis of the environment information, obtained at predetermined intervals, around the moving object when the moving object is moving.

11. The method of claim 7, wherein said creating the local map comprises generating the local map within a predetermined range with respect to the position of the moving object on the basis of the environment information during the moving object is moving.

12. The method of claim 7, wherein said estimating the position of the moving object comprises:
extracting the attribute information including lanes, height of obstacles, and road marks from the local map; and
estimating the position of the moving object on the global map through matching between information of the global map and the extracted information.
